(19) United States
(12) Patent Application Publication
(10) Pub. No.: US 2009/0146765 A1
(43) Pub. Date: Jun. 11, 2009

(54) Down-converter Having Matching Circuits with Tuning Mechanism Coupled to 90-Degree Hybrid Coupler Included Therein

(76) Inventors: Tzong-Jyh Chen, Taipei Hsien (TW); Min-Chieh Kang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/125,940

(22) Filed: May 23, 2008

(30) Foreign Application Priority Data
Dec. 10, 2007 (TW) 096147007

(51) Int. Cl. H01P 1/17

(52) U.S. Cl. 333/21 A; 333/117; 330/286

(57) ABSTRACT

A down-converter includes two low-noise amplifiers, a 90-degree hybrid coupler, two first matching circuits, and a down-converting circuit. The two low-noise amplifiers respectively amplify a first beacon signal and a second beacon signal to generate a first amplified signal and a second amplified signal. The 90-degree hybrid coupler includes two input ports and two output ports for transforming the first amplified signal and the second amplified signal into a first coupler output signal and a second coupler output signal. The two first matching circuits are respectively coupled to the two input ports or the two output ports of the 90-degree hybrid coupler and each first matching circuit has a first tuning mechanism disposed in one side of the first matching circuit and not contacting the first matching circuit. The down-converting circuit performs a frequency down-conversion on the first coupler output signal and the second coupler output signal.

### BACKGROUND OF THE INVENTION

1. Field of the Invention

The present invention relates to a wireless receiving apparatus, and more particularly, to a down-converter (such as an LNB) applying matching circuits with a tuning mechanism to input ports and/or output ports of the 90-degree hybrid coupler to adjust cross polarization isolation (CPI).

2. Description of the Prior Art

Recently, requirements for satellite receiving systems have increased year by year due to satellite communication services having characteristics of wide bandwidth, data broadcasting, and being borderless. However, the resources for satellite bandwidth are finite. Thus, transmission manners such as linear polarization transmission and circular polarization transmission are developed to make better use of the satellite bandwidth. The linear polarization transmission includes vertical linear polarization (VLP) and horizontal linear polarization (HLP), wherein the magnitude of its electric field varies over time but the direction of the electric field remains the same. The circular polarization transmission includes right-hand circular polarization (RHCP) and left-hand circular polarization (LHCP), wherein the magnitude of its electric field does not vary over time, but the direction of the electric field does. Generally speaking, antennas with a same polarization type are used for receiving satellite signals with the same polarization type, but antennas with different polarization types may be used for receiving satellite signals with different polarization types due to certain antenna designs. For example, a linear polarization antenna can be used for receiving circular polarization waveforms. In such conditions, because the linear polarization antenna only catches linear polarization component signals (i.e., VLP component signals and HLP component signals) corresponding to the RHCP signal and the LHCP signal, the VLP component signals and HLP component signals received by the linear polarization antenna need to be combined to form the RHCP signal and the LHCP signal through a 90-degree hybrid coupler.

Please refer to FIG.1. FIG.1 is a diagram showing an architecture of a 90-degree hybrid coupler 100 according to the prior art. The 90-degree hybrid coupler 100 includes a coupler body 180, wherein the coupler body 180 includes a first input port 110, a second input port 120, a first output port 130, and a second output port 140. The first input port 110 and the second input port 120 are respectively used for receiving a VLP signal S_{VLP} and an HLP signal S_{HLP}, and the first output port 130 and the second output port 140 are respectively used for outputting an RHCP signal S_{RHCP} and an LHCP signal S_{LHCP}.

In such a conventional architecture, the amplitude and phase of the VLP signal S_{VLP} and the HLP signal S_{HLP} at the front-end of the 90-degree hybrid coupler 100 (i.e., the first input port 110 and the second input port 120) must maintain balance, otherwise, not only the RHCP signal but also the LHCP signal occur at the first output port 130, wherein a ratio of the RHCP signal to the LHCP signal is called cross polarization isolation (CPI). Similarly, the second input port 120 has another CPI. In other words, if the difference of the amplitude and the phase between the HLP signal S_{HLP} and the VLP signal S_{VLP} gets smaller, the RHCP signal S_{RHCP} and the LHCP signal S_{LHCP} combined by the 90-degree degree hybrid coupler have better CPI. Furthermore, the matching of the elements at the back-end of the 90-degree hybrid coupler 100 will also affect the CPI.

Because the conventional 90-degree hybrid coupler 100 has the advantages of easy design and simple manufacturing, it is frequently applied to low noise block down-converters (LNB). However, balance and matching characteristics on polarization paths are not good enough due to element differences resulting from manufacturing processes and a non-consistency of PCB etching process. Therefore, the whole CPI of the LNB will be affected, which even results in a production yield rate issue.

### SUMMARY OF THE INVENTION

It is one of the objectives of the present invention to provide a down-converter (such as an LNB) capable of adjusting cross polarization isolation (CPI) to solve the abovementioned problems.

The present invention provides a down-converter. The down-converter includes two low-noise amplifiers, a 90-degree hybrid coupler, two first matching circuits, and a down-converting circuit. The low-noise amplifiers are respectively used for amplifying a first beacon signal and a second beacon signal to generate a first amplified signal and a second amplified signal. The 90-degree hybrid coupler is used for transforming the first amplified signal and the second amplified signal into a first coupler output signal and a second coupler output signal. The 90-degree hybrid coupler includes two input ports and two output ports. The two input ports are respectively used for receiving the first amplified signal and the second amplified signal. The two output ports are respectively used for outputting the first coupler output signal and the second coupler output signal. The two first matching circuits are respectively coupled to the 90-degree hybrid coupler. Each first matching circuit has a first tuning mechanism disposed in one side of the first matching circuit and not contacting the first matching circuit, wherein the first tuning mechanism is used for adjusting characteristics of the first matching circuit. The down-converting circuit is used for down-converting the first coupler output signal and the second coupler output signal.

In one embodiment, the two first matching circuits are respectively coupled to the two input ports of the 90-degree hybrid coupler.

In one embodiment, the two first matching circuits are respectively coupled to the two output ports of the 90-degree hybrid coupler.

In one embodiment, the down-converter further includes two second matching circuits respectively coupled to the two output ports of the 90-degree hybrid coupler. Each second matching circuit has a second tuning mechanism disposed in one side of the second matching circuit and not contacting the second matching circuit, wherein the second tuning mechanism is used for adjusting characteristics of the second matching circuit. The two first matching circuits are respectively coupled to the two input ports of the 90-degree hybrid coupler.

In one embodiment, the first tuning mechanism and the second tuning mechanism are screws.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing an architecture of a 90-degree hybrid coupler according to the prior art.

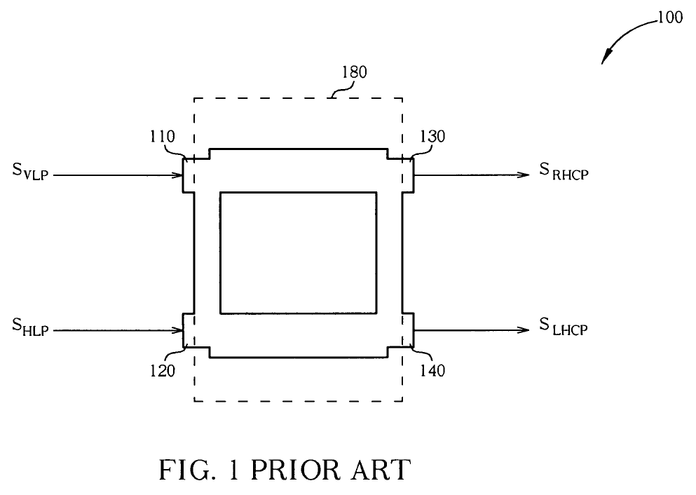

FIG. 2 is a block diagram of a down-converter according to an embodiment of the present invention.

FIG. 3 is a lateral view of an example of the first matching circuit and the second matching circuit with tuning mechanism shown in FIG. 2.

FIG. 4 is a diagram showing varied embodiments of the tuning mechanism shown in FIG. 3.

FIG. 5 is a diagram showing a configuration of the 90-degree hybrid coupler, the first matching circuits, the second matching circuits, and the low-noise amplifiers in FIG. 2 on a printed circuit board.

### DETAILED DESCRIPTION

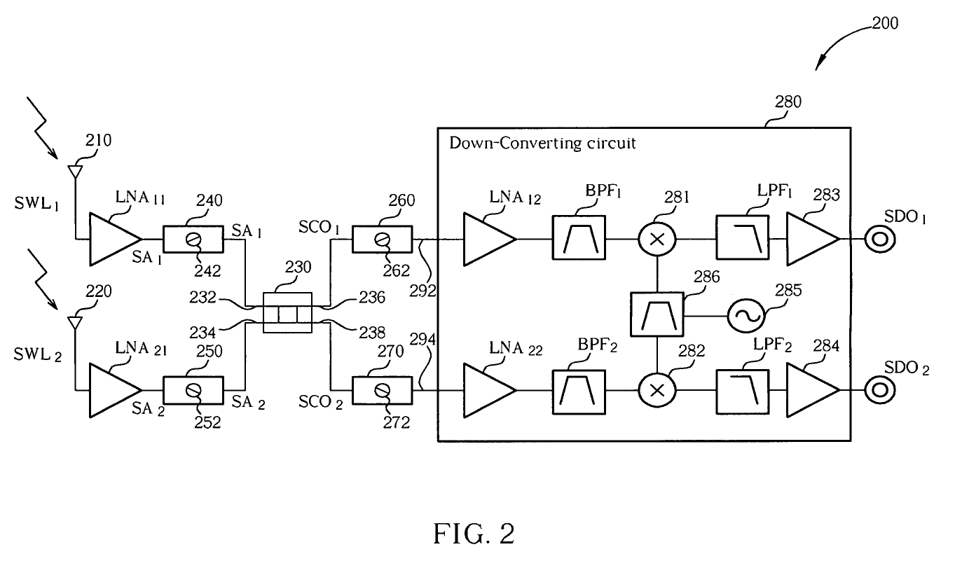

Please refer to FIG. 2. FIG. 2 is a block diagram of a down-converter 200 according to an embodiment of the present invention. In this embodiment, the down-converter 200 can be an LNB, but this is not a limitation of the present invention and it can be a down-converter of a different type. The down-converter 200 includes two antennas 210 and 220, two low-noise amplifiers LNA₁₁ and LNA₂₁, a 90-degree hybrid coupler 230, two first matching circuits 240 and 250, two second matching circuits 260 and 270, and a down-converting circuit 280. The antenna 210 and the antenna 220 are respectively used for receiving a first beacon signal SWL₁ and a second beacon signal SWL₂. The low-noise amplifiers LNA₁₁ and LNA₂₁ are respectively coupled to the antenna 210 and the antenna 220 and are respectively used for amplifying the first beacon signal SWL₁ and the second beacon signal SWL₂ to generate a first amplified signal SA₁ and a second amplified signal SA₂. The 90-degree hybrid coupler 230 transforms the first amplified signal SA₁ and the second amplified signal SA₂ into a first coupler output signal SCO₁ and a second coupler output signal SCO₂. The 90-degree hybrid coupler 230 includes a first input port 232, a second input port 234, a first output port 236, and a second output port 238. The first input port 232 and the second input port 234 are respectively coupled to the two first matching circuits 240 and 250 for receiving the first amplified signal SA₁ and the second amplified signal SA₂. The first output port 236 and the second output port 238 are respectively coupled to the two second matching circuits 260 and 270 used for respectively outputting the first coupler output signal SCO₁ and the second coupler output signal SCO₂. The down-converting circuit 280 includes two input ends 292 and 294 respectively coupled to the two second matching circuits 260 and 270 for down-converting the first coupler output signal SCO₁ and the second coupler output signal SCO₂ to generate a first down-converted output signal SDO₁ and a second down-converted output signal SDO₂.

Please keep referring to FIG. 2. Each of the first matching circuits 240 and 250 has a first tuning mechanism 242 and 252, which are respectively used for adjusting characteristics of the first matching circuits 240 and 250 (i.e., adjusting the balance of the amplitude and phase of the first amplified signal SA₁ and the second amplified signal SA₂). In addition, each of the second matching circuits 260 and 270 also has a second tuning mechanism 262 and 272, which are respectively used for adjusting characteristics of the second matching circuits 260 and 270 (i.e., adjusting the matching between the first output port 236 and the second output port 238 and the two input ports 292 and 294 of the down-converting circuit 280). The configurations and operations of the first matching circuits 240 and 250, the first tuning mechanisms 242 and 252, the second matching circuits 260 and 270, and the second tuning mechanisms 262 and 272 will be detailed in the following figures and embodiments.

Please note that, the abovementioned embodiment is presented merely for illustrating practicable designs of the down-converter 200 with tuning mechanism of the present invention, and should not be limitations of the present invention. As can be known above, the first tuning mechanisms 242 and 252 and the second tuning mechanisms 262 and 272 can be respectively added to the four ports of the 90-degree hybrid coupler 230. Note that if only the first tuning mechanisms 242 and 252 are added to the first input port 232 and the second input port 234, at this time, the characteristics of the first matching circuits 240 and 250 can also be adjusted to improve the CPI at the front-end of the 90-degree hybrid coupler 230. Similarly, if only the second tuning mechanisms 262 and 272 are added to the first output port 236 and the second output port 238, at this time, the characteristics of the second matching circuits 260 and 270 can also be adjusted to improve the CPI at the back-end of the 90-degree hybrid coupler 230, which should also belong to the scope of the present invention. Those skilled in the art should appreciate that various modifications may be made without departing from the spirit of the present invention.

In this embodiment, the down-converting circuit 280 includes two low-noise amplifiers LNA₁₂ and LNA₂₂, two first band-pass filters BPF₁ and BPF₂, two mixers 281 and 282, two low-pass filters LPF₁ and LPF₂, two amplifiers 283 and 284, a local oscillator 285, and a second band-pass filter 286, wherein a connection manner of each element is shown in FIG. 2. Please note that the operations of each element of the down-converting circuit 280 are not emphases of the present invention, and further description for the down-converting circuit 280 is omitted here for brevity. In addition, the abovementioned down-converting circuit 280 is merely an embodiment of the present invention, and those skilled in the art should appreciate that it should not be considered to be limitations of the scope of the present invention. For example, the stages of the low-noise amplifiers LNA₁₂ and LNA₂₂ can be increased or removed depending on design structures.

Please note that the 90-degree hybrid coupler 230 mentioned above is merely an implementation, but is not limited to this only and can be 90-degree hybrid coupler of another type. The first beacon signal SWL₁ and the second beacon signal SWL₂ are both satellite signals. For example, in one embodiment, the down-converter 200 is used for receiving an LHCP signal and a RHCP signal. The antenna 210 (such as a horizontal linear polarization antenna) is used for receiving an HLP component signal corresponding to the LHCP signal and an HLP component signal corresponding to the RHCP signal. The antenna 220 (such as a vertical linear polarization antenna) is used for receiving a VLP component signal corresponding to the LHCP signal and a VLP component signal corresponding to the RHCP signal. After the combination of the 90-degree hybrid coupler 230, the HLP component signal corresponding to the LHCP signal and the VLP component signal corresponding to the LHCP signal are combined into the LHCP signal to generate the first coupler output signal SCO₁, and the HLP component signal corresponding to the RHCP signal and the VLP component signal corresponding to the RHCP signal are combined into the RHCP signal to generate the second coupler output signal SCO₂. In other words, the first beacon signal SWL₁ includes the HLP component signal corresponding to the LHCP signal and the HLP component signal corresponding to the RHCP signal, the second beacon signal SWL₂ includes the VLP component signal corresponding to the LHCP signal and the VLP component signal corresponding to the RHCP signal, the first coupler output signal SCO₁ includes the LHCP signal, and the second coupler output signal SCO₂ includes the RHCP signal. In another embodiment, the down-converter 200 is used for receiving an HLP signal and a VLP signal. The antenna 210 (such as a left-hand circular polarization antenna) is used for receiving an LHCP component signal corresponding to the HLP signal and an LHCP component signal corresponding to the VLP signal. The antenna 220 (such as a right-hand circular polarization antenna) is used for receiving a RHCP component signal corresponding to the HLP signal and a RHCP component signal corresponding to the VLP signal. After the combination of the 90-degree hybrid coupler 230, the LHCP component signal corresponding to the HLP signal and the RHCP component signal corresponding to the HLP signal are combined into the HLP signal to generate the first coupler output signal SCO₁, and the LHCP component signal corresponding to the VLP signal and the RHCP component signal corresponding to the VLP signal are combined into the VLP signal to generate the second coupler output signal SCO₂. In other words, the first beacon signal SWL₁ includes the LHCP component signal corresponding to the HLP signal and the LHCP component signal corresponding to the VLP signal, the second beacon signal SWL₂ includes the RHCP component signal corresponding to the HLP signal and the RHCP component signal corresponding to the VLP signal, the first coupler output signal SCO₁ includes the HLP signal, and the second coupler output signal SCO₂ includes the VLP signal.

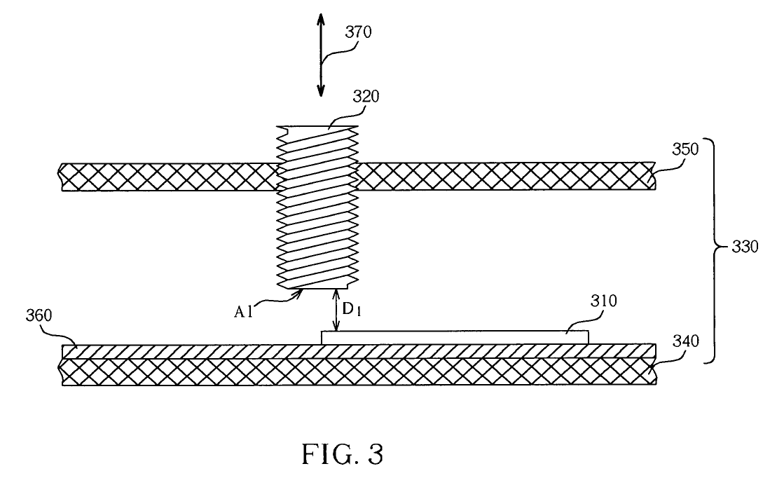

Please refer to FIG. 3. FIG. 3 is a lateral view of an example of the first matching circuits 240 and 250 and the second matching circuits 260 and 270 with tuning mechanism shown in FIG. 2. As shown in FIG. 3, a tuning mechanism 320 is disposed in one side of a matching circuit 310 without contacting the matching circuit 310. The matching circuit 310 is disposed on a printed circuit board (PCB) 360 through a layout, and the PCB 360 is located on a first plane 340 of a housing 330. The tuning mechanism 320 is disposed on a second plane 350 of the housing 330, wherein the first plane 340 is substantially parallel to the second plane 350. The tuning mechanism 320 has an area A1 and there is a distance D₁ existing between the tuning mechanism 320 and the matching circuit 310, wherein the area A1 and the distance D₁ are related to the characteristics of the matching circuit 310. In other words, a coupling capacitor effect is generated between the tuning mechanism 320 and the matching circuit 310, therefore, the characteristics of the matching circuit 310 can be adjusted through modifying the area A1 and the distance D₁. The distance D₁ can be adjusted through the direction indicated by an arrow 370.

Please note that the tuning mechanism 320 can be constructed of a metallic material (i.e., conductive material), such as a screw, but this is not a limitation of the present invention and it can be implemented by other elements. Furthermore, the area A1 and the distance D₁ are not fixed values and can be designed depending on practical requirements.

Please also note that, the tuning mechanism 320 is merely an embodiment of the present invention, and, as is well known by persons of ordinary skill in the art, suitable variations can be applied to the tuning mechanism 320. In the following, several embodiments illustrate various modifications of the tuning mechanism 320.

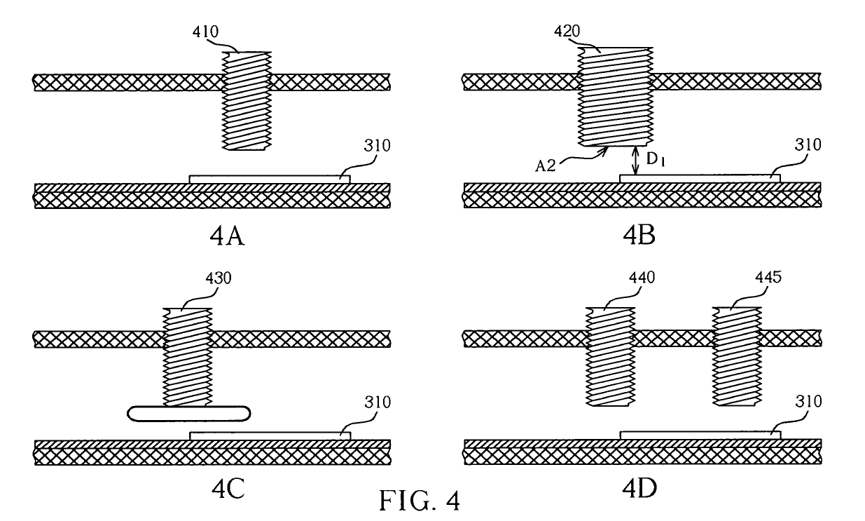

Please refer to FIG. 4. FIG. 4 is a diagram showing varied embodiments of the tuning mechanism 320 shown in FIG. 3. In 4A, the tuning mechanism 410 is similar to the tuning mechanism 320 shown in FIG. 3, and the difference between them is that the relative location of the tuning mechanism 410 and the matching circuit 310 is different from that in FIG. 3 In 4B, the difference between a tuning mechanism 420 and the tuning mechanism 320 shown in FIG. 3 is that the tuning mechanism 420 has an area A2 being greater than the area A1 of the tuning mechanism 320. In 4C, the difference between a tuning mechanism 430 and the tuning mechanism 320 shown in FIG. 3 is that their shapes are different from each other. In 4D, a number of tuning mechanisms of the matching circuit is different from that in FIG. 3, wherein two tuning mechanism 440 and 445 are adopted in 4D.

Those skilled in the art should appreciate that various modifications of the tuning mechanism may be made without departing from the spirit of the present invention. The abovementioned embodiments are presented merely for illustrating practicable designs of the present invention, and should not be considered to be limitations of the present invention. Furthermore, the arranged location, the area, the shape, and the number of the tuning mechanism are not limited and can be adjusted depending on design requirements.

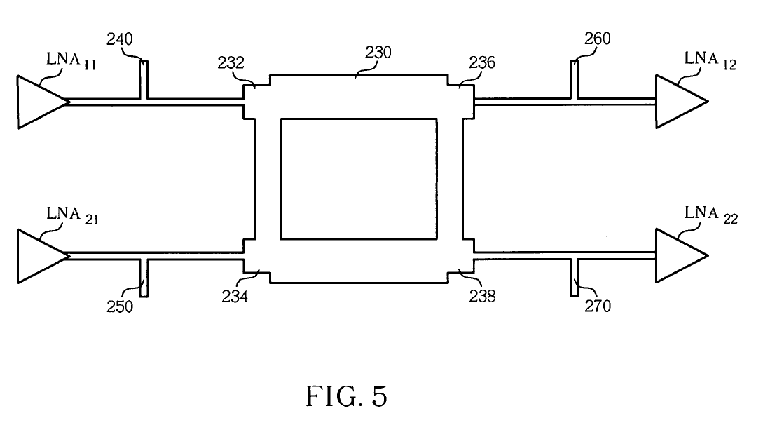

Please refer to FIG. 5 together with FIG. 2. FIG. 5 is a diagram showing a configuration of the 90-degree hybrid coupler 230, the first matching circuits 240 and 250, the second matching circuits 260 and 270, and the low-noise amplifiers LNA₁₁, LNA₁₂, LNA₂₁, and LNA₂₂ in FIG. 2 on a printed circuit board. For easy description, the same symbols are adopted for representing the same elements mentioned in the embodiments above. The first matching circuits 240 and 250 and the second matching circuits 260 and 270 can be implemented by the matching circuit 310 shown in FIG. 3, which are disposed on the PCB through a layout. In addition, the first tuning mechanisms 242 and 252 and the second turning mechanisms 262 and 272 can be implemented by the tuning mechanism 320 shown in FIG. 3. The configuration and the operations of the matching circuit 310 and the tuning mechanism 320 are already detailed above (please refer to FIG. 3) and further description is omitted here for brevity. Of course, the first tuning mechanisms 242 and 252 and the second tuning mechanisms 262 and 272 can also be implemented by changed forms of the tuning mechanism 320, such as the tuning mechanisms shown in FIG. 4 or any combinations of them.

From the above descriptions, the present invention provides the down-converter 200 capable of adjusting CPI. Through additionally disposing tuning mechanisms to the two input ports, the two output ports, or all ports of the matching circuits of the 90-degree hybrid coupler, the characteristics of the matching circuits can be adjusted to reduce cross polarization interference. Especially, solutions to the problems, for example, balance and matching characteristics on polarization paths are not good enough, resulted from element differences and PCB etching process, and can be improved. Therefore, linear polarization antennas can be used for receiving the RHCP signal and the LHCP signal if the 90-degree hybrid coupler disclosed in the present invention is adopted. In addition, because the cross polarization interference of the 90-degree hybrid coupler can be avoided, the receiving efficiency of the LNB is improved. Furthermore, the architectures of the tuning mechanism are very simple and can be manufactured cheaply, which will not increase difficulties in design and extra costs.

Those skilled in the art will readily observe that numerous modifications and alterations of the device and method may be made while retaining the teachings of the invention.

What is claimed is:

1. A down-converter, comprising:
two low-noise amplifiers, for respectively amplifying a first beacon signal and a second beacon signal to generate a first amplified signal and a second amplified signal;
a 90-degree hybrid coupler, for transforming the first amplified signal and the second amplified signal into a first coupler output signal and a second coupler output signal, the 90-degree hybrid coupler comprising:
two input ports, for respectively receiving the first amplified signal and the second amplified signal; and
two output ports, for respectively outputting the first coupler output signal and the second coupler output signal;
two first matching circuits, respectively coupled to the 90-degree hybrid coupler, each first matching circuit having a first tuning mechanism disposed in one side of the first matching circuit and not contacting the first matching circuit, wherein the first tuning mechanism is used for adjusting characteristics of the first matching circuit; and
a down-converting circuit, for down-converting the first coupler output signal and the second coupler output signal.

2. The down-converter of claim 1, wherein the two first matching circuits are respectively coupled to the two input ports of the 90-degree hybrid coupler.

3. The down-converter of claim 1, wherein the two first matching circuits are respectively coupled to the two output ports of the 90-degree hybrid coupler.

4. The down-converter of claim 1, further comprising:
two second matching circuits, respectively coupled to the two output ports of the 90-degree hybrid coupler, each second matching circuit having a second tuning mechanism disposed in one side of the second matching circuit and not contacting the second matching circuit, wherein the second tuning mechanism is used for adjusting characteristics of the second matching circuit;
wherein the two first matching circuits are respectively coupled to the two input ports of the 90-degree hybrid coupler.

5. The down-converter of claim 4, wherein the first tuning mechanism and the second tuning mechanism are constructed of metallic material.

6. The down-converter of claim 5, wherein the first tuning mechanism and the second tuning mechanism are each a screw.

7. The down-converter of claim 4, wherein:
the first tuning mechanism has a first area and there is a first distance existing between the first tuning mechanism and the first matching circuit, wherein the first area and the first distance are related to the characteristics of the first matching circuit; and
the second tuning mechanism has a second area and there is a second distance existing between the second tuning mechanism and the second matching circuit, wherein the second area and the second distance are related to the characteristics of the second matching circuit.

8. The down-converter of claim 1, wherein:
the first tuning mechanism has a first area and there is a first distance existing between the first tuning mechanism and the first matching circuit, wherein the first area and the first distance are related to the characteristics of the first matching circuit.

9. The down-converter of claim 1, wherein the first tuning mechanism is constructed of metallic material.

10. The down-converter of claim 9, wherein the first tuning mechanism is a screw.

11. The down-converter of claim 1, wherein the down-converter is used for receiving a left-hand circular polarization (LHCP) signal and a right-hand circular polarization (RHCP) signal; the first beacon signal comprises a horizontal linear polarization (HLP) component signal corresponding to the LHCP signal and an HLP component signal corresponding to the RHCP signal, and the second beacon signal comprises a vertical linear polarization (VLP) component signal corresponding to the LHCP signal and a VLP component signal corresponding to the RHCP signal; and the first coupler output signal comprises the LHCP signal and the second coupler output signal comprises the RHCP signal.

12. The down-converter of claim 1, wherein the down-converter is used for receiving an HLP signal and a VLP signal; the first beacon signal comprises an LHCP component signal corresponding to the HLP signal and an LHCP component signal corresponding to the VLP signal, and the second beacon signal comprises a RHCP component signal corresponding to the HLP signal and a RHCP component signal corresponding to the VLP signal; and the first coupler output signal comprises the HLP signal and the second coupler output signal comprises the VLP signal.

13. The down-converter of claim 1, wherein the down-converter is a low noise block down-converter (LNB), and the first beacon signal and the second beacon signal are both satellite signals.

14. A down-converter, comprising:
a 90-degree hybrid coupler, having a first input port, a second input port, a first output port, and a second output port;
two first matching circuits, respectively coupled to the first input port and the second input port, each first matching circuit having a first tuning mechanism for adjusting characteristics of the first matching circuit;
two second matching circuits, respectively coupled to the first output port and the second output port, each second matching circuit having a second tuning mechanism for adjusting characteristics of the second matching circuit; and
a down-converting circuit, coupled to the two second matching circuits.

15. The down-converter of claim 14, wherein the first input port is used for receiving an HLP component signal corresponding to an LHCP signal and an HLP component signal corresponding to a RHCP signal, and the second input port is used for receiving a VLP component signal corresponding to the LHCP signal and a VLP component signal corresponding to the RHCP signal.

16. The down-converter of claim 15, wherein the first output port is used for outputting the LHCP signal and the second output port is used for outputting the RHCP signal.

17. The down-converter of claim 14, wherein the first input port is used for receiving an LHCP component signal corresponding to an HLP signal and an LHCP component signal corresponding to a VLP signal, and the second input port is used for receiving a RHCP component signal corresponding to the HLP signal and a RHCP component signal corresponding to the VLP signal.

18. The down-converter of claim 17, wherein the first output port is used for outputting the HLP signal and the second output port is used for outputting the VLP signal.

19. The down-converter of claim 14, wherein the first tuning mechanism and the second tuning mechanism are constructed of metallic material.

20. The down-converter of claim 19, wherein the first tuning mechanism and the second tuning mechanism are each a screw.
